(19) United States
(12) Patent Application Publication
(10) Pub. No.: US 2014/0197080 A1
(43) Pub. Date: Jul. 17, 2014

(54) SORTING APPARATUS FOR SORTING SCREWS OF VARIED TYPES

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: CHIH-HAO YANG, New Taipei (TW); XIANG-KUN ZENG, Shenzhen (CN); CHENG HAO, Shenzhen (CN); RUN LONG, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/051,705

(22) Filed: Oct. 11, 2013

(30) Foreign Application Priority Data
Jan. 17, 2013 (CN) 2013100170652

(51) Int. Cl. B07B 13/04

(52) U.S. Cl. CPC B07B 13/04
USPC 209/659

(57) ABSTRACT

A sorting apparatus for sorting screws includes a first restricting piece, a second restricting piece, and a diversion block. A first pathway is defined between the first restricting piece and the second restricting piece. A second pathway is defined between the first restricting piece and the diversion block. A fourth pathway is defined between the second restricting piece and the diversion block. The first blocking piece is located in the second pathway adjacent to the first pathway. The first blocking piece blocks a long screw to prevent the long screw from sliding from the first pathway to the second pathway and guides the long screw to slide from the first pathway to the fourth pathway. The first blocking piece lets a short screw slide from the first pathway to the second pathway.

### BACKGROUND

1. Technical Field

The present disclosure relates to a sorting apparatus, and particularly to a sorting apparatus for sorting different kinds of screws.

2. Description of Related Art

To assemble a product, may types of screws are often needed. However, when the screws are mixed together before assembly, it is difficult to distinguish the screws from each other.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of an embodiment of a sorting apparatus for sorting screws.

FIG. 2 is a top view of the sorting apparatus of FIG. 1.

FIG. 3 is another isometric view of the sorting apparatus of FIG. 1.

FIG. 4 is an isometric view of another embodiment of a sorting apparatus for sorting screws.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

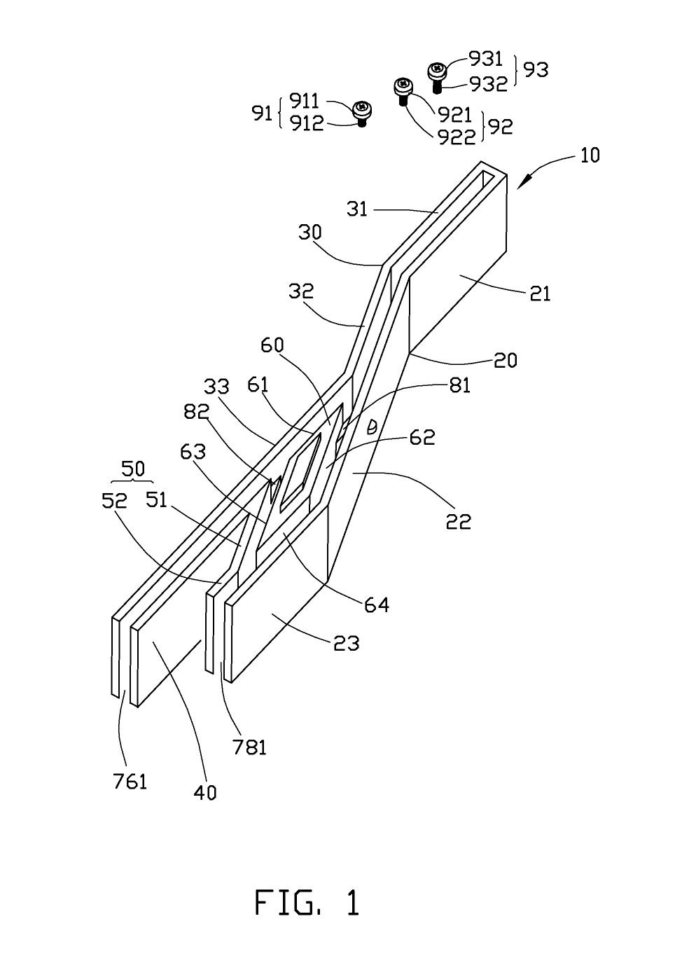

FIG. 1 shows that an embodiment of a sorting apparatus 10 for sorting different kinds of screws includes a first restricting piece 20, a second restricting piece 30, a third restricting piece 40, a fourth restricting piece 50, and a diversion block 60. The first restricting piece 20, the second restricting piece 30, and the fourth restricting piece 50 are bent pieces. The diversion block 60 is substantially diamond-shaped.

The first restricting piece 20 includes a first section 21, a second section 22, and a third section 23. The second restricting piece 30 includes a first section 31, a second section 32, and a third section 33. The fourth restricting piece 50 includes a first section 51 and a second section 52. The diversion block 60 includes a first side face 61, a second side face 62, a third side face 63, and a fourth side face 64. The first side face 61 is substantially parallel to the third side face 63. The second side face 62 is parallel to the fourth side face 64. Top portions of the first restricting piece 20, the second restricting piece 30, the third restricting piece 40, the fourth restricting piece 50, and the diversion block 60 are coplanar.

The first section 21 of the first restricting piece 20 is parallel to and faces the first section 31 of the second restricting piece 30. An initial pathway 71 is defined between the first section 21 and the first section 31. A front portion of the second section 22 is parallel to and faces the second section 32. A first pathway 72 is defined between the front portion of the second section 22 and the second section 32.

The diversion block 60 is located between the first restricting piece 20 and the second restricting piece 30. A rear portion of the second section 22 is parallel to and faces the second side face 62 of the diversion block 60. A second pathway 73 is defined between the rear portion of the second section 22 and the second side face 62. The third section 23 of the first restricting piece 20 is parallel to and faces the fourth side face 64. A third pathway 74 is defined between the third section 23 and the fourth side face 64.

A front portion of the third section 33 is parallel to and faces the first side face 61. A fourth pathway 75 is defined between the front portion of the third section 33 and the first side face 61. A rear section of the third section 33 is parallel to and faces the third restricting piece 40. A fifth pathway 76 is defined between the rear portion of the third section 33 and the third restricting piece 40. A distal end of the fifth pathway 76 defines a first outlet 761.

The first section 51 of the fourth restricting piece 50 is parallel to and faces the third side face 63. A sixth pathway 77 is defined between the first section 51 and the third side face 63. The second section 52 of the fourth restricting piece 50 is parallel to and faces a rear section of the third section 23. A seventh pathway 78 is defined between the rear section of the third section 23 and the second section 52 of the fourth restricting piece 50. A distal end of the seventh pathway 78 defines a second outlet 781.

The initial pathway 71, the first pathway 72, the second pathway 73, the third pathway 74, the fourth pathway 75, the fifth pathway 76, the sixth pathway 77, and the seventh pathway 78 have a substantially same width.

An extending direction of the first pathway 72 is the same as that of the second pathway 73. An extending direction of the third pathway 74 is the same as that of the seventh pathway 78. An extending direction of the fourth pathway 75 is the same as that of the fifth pathway 76.

A first blocking piece 81 is located in the second pathway 73 adjacent to the first pathway 72. A top portion of the first blocking piece 81 is located below the top portion of the first restricting piece 20. A distance between the top portion of the first blocking piece 81 and the top portion of the first restricting piece 20 is a first distance H1. A second blocking piece 82 is located in the fifth pathway 76 adjacent to the fourth pathway 75. A top portion of the first blocking piece 81 is located below the top portion of the second restricting piece 30. A distance between the top portion of the first blocking piece 81 and the top portion of the second restricting piece 30 is a second distance H2. The second distance H2 is larger than the first distance H1.

A plurality of different kinds of screws is slidable in the sorting apparatus 10 to be filtered. For example, a first screw 91, a second screw 92, and a third screw 93 can be filtered by the sorting apparatus 10. The first screw 91 includes a first screw cap 911 and a first screw pole 912. A length of the first screw pole 912 is shorter than the first distance H1. The second screw 92 includes a second screw cap 921 and a second screw pole 922. A length of the second screw pole 922 is longer than the first distance H1, but shorter than the second distance H2. The third screw 93 includes a third screw cap 931 and a third screw pole 932. A length of the third screw pole 933 is longer than the second distance H2. Diameters of the first screw cap 911, the second screw cap 921, and the third screw cap 931 are larger than the width of the initial pathway 71. Diameters of the first screw pole 912, the second screw pole 922, and the third screw pole 932 are smaller than the width of the initial pathway 71.

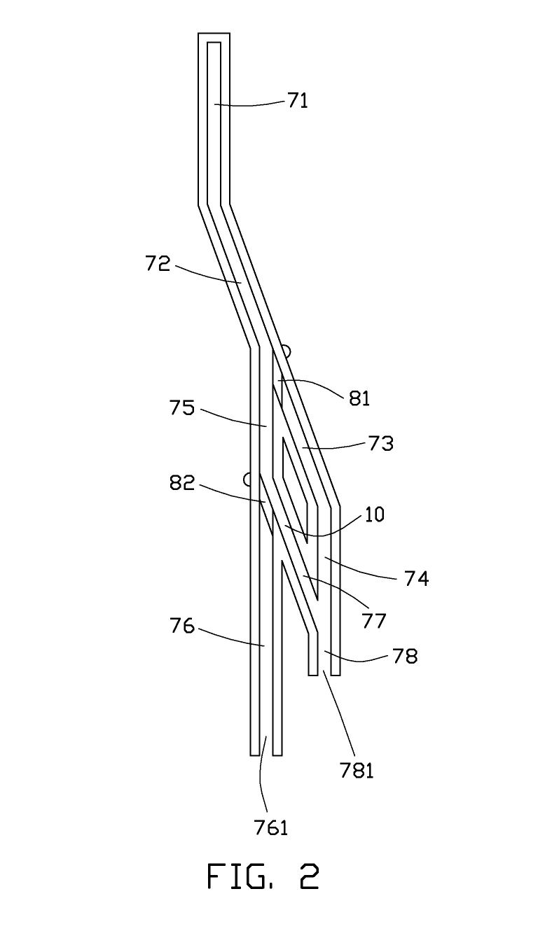

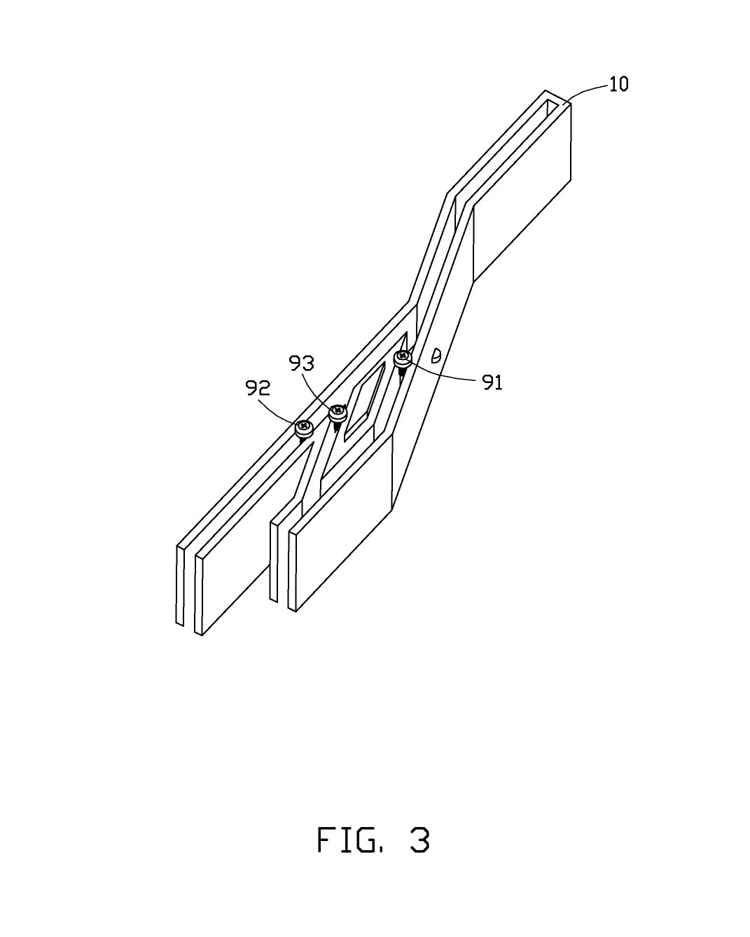

Referring to FIGS. 1 to 3, to use the sorting apparatus 10 to sort screws, the first screw 91, the second screw 92, and the third screw 93 are placed in the initial pathway 71. The first screw cap 911, the second screw cap 921, and the third screw cap 931 are located above the top portions of the first restricting piece 20 and the second restricting piece 30.

The first screw 91, the second screw 92, and the third screw 93 slide from the initial pathway 71 to the first pathway 72. Because the extending directions of the first pathway 72 and the second pathway 73 are the same, the first screw 91, the second screw 92, and the third screw 93 slide from the first pathway 72 to the second pathway 73. However, because lengths of the second screw pole 922 and the third screw pole 932 are longer than the first distance H1, the second screw 92 and the third screw 93 are blocked by the first blocking piece 81. Therefore, the second screw 92 and the third screw 93 are blocked from sliding in the pathway 73 and slide into the fourth pathway 75. The first screw 91 slides in the second pathway 73. The first screw 91 further slides out of the sorting apparatus 10 from the second outlet 781 via the third pathway 74 and the seventh pathway 78.

Because the extending directions of the fourth pathway 75 and the fifth pathway 76 are the same, the second screw 92 and the third screw 93 slide from the fourth pathway 75 to the fifth pathway 76. However, because the length of the third screw pole 932 is larger than the second distance H2, the third screw 93 is blocked by the second blocking piece 82. The third screw 93 is blocked from sliding in the fifth pathway 76 and slides in the sixth pathway 77. The third screw 93 further slides out of the sorting apparatus 10 from the second outlet 781 via the seventh pathway 78. The second screw 92 slides in the fifth pathway 76 and slides out of the sorting apparatus 10 from the first outlet 761.

The above sorting apparatus 10 sorts the second screw 92 from the first screw 91 and the third screw 93.

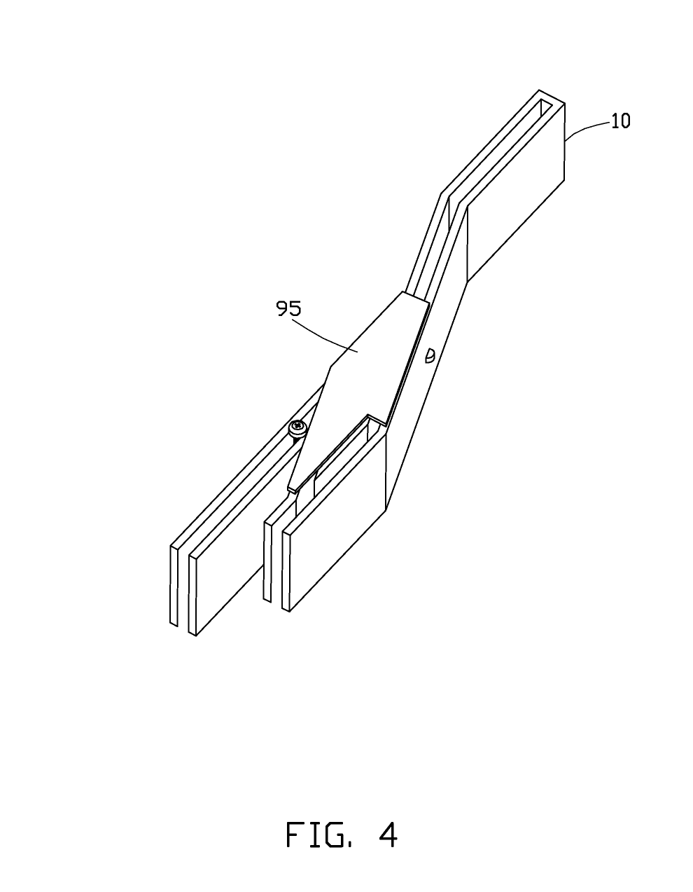

Referring to FIG. 4, in another embodiment, a cover 95 is mounted above the diversion block 60 to prevent the screws from jumping out of the pathways.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A sorting apparatus for sorting screws, comprising:
a first restricting piece;
a second restricting piece, a first pathway defined between the first restricting piece and the second restricting piece;
a diversion block located between the first restricting piece and the second restricting piece, a second pathway defined between the first restricting piece and the diversion block, a fourth pathway defined between the second restricting piece and the diversion block; and
a first blocking piece located in the second pathway and adjacent to the first pathway, wherein the first blocking piece is configured to block a long screw from sliding from the first pathway to the second pathway and to guide the long screw sliding form the first pathway to the fourth pathway, the first blocking piece is configured to allow a short screw slide from the first pathway to the second pathway.

2. The sorting apparatus of claim 1, wherein widths of the first pathway, the second pathway, and fourth pathway are the same, a width of the first pathway is narrower than diameters of screw caps of the long and the short screws, and the width of the first pathway is wider than diameters of screw poles of the long and the short screws.

3. The sorting apparatus of claim 2, wherein top portions of the first and the second restricting pieces are placed below the screw caps of the long and the short screws.

4. The sorting apparatus of claim 2, wherein top portions of the first restricting piece, the second restricting piece, and the diversion block are located on a same plane.

5. The sorting apparatus of claim 4, wherein a top portion of the first block is located below the a top portion of the first restricting piece, a distance between the top portion of the first restricting piece and the top portion of the first block is smaller than a length of the screw pole of the long screw and larger then a length of the screw pole of the short screw.

6. The sorting apparatus of claim 1, wherein a cover is mounted above the diversion block to pervert the long and the short screws from jumping out of the sorting apparatus.

7. The sorting apparatus of claim 1, wherein extending directions of the first pathway and the second pathway are the same.

8. The sorting apparatus of claim 1, wherein the diversion block comprises a first side face, the second restricting piece is parallel to and faces to the first side face, and the fourth pathway is defined between the second restricting piece and the first side face.

9. The sorting apparatus of claim 8, wherein the diversion block further comprises a second side face, the first restricting piece is parallel to and faces to the second side face, and the second pathway is defined between the first restricting piece and the second side face.

10. The sorting apparatus of claim 9, wherein the first second side face and the second side face are crossed.

11. A sorting apparatus for sorting screws, comprising:
a first pathway;
a second pathway communicating with the first pathway, extending directions of the second pathway and the first pathway being same;
a fourth pathway communicating with the first pathway, extending directions of the fourth pathway and the first pathway being different; and
a first blocking piece located in the second pathway and facing the fourth pathway;
wherein the first blocking piece is configured to block a long screw from sliding from the first pathway to the second pathway and to guide the long screw sliding form the first pathway to the fourth pathway, the first blocking piece is configured to allow a short screw slide from the first pathway to the second pathway.

12. The sorting apparatus of claim 11, further comprising a first restricting piece, a second restricting piece, and a diverting piece, wherein the first pathway are defined between the first restricting piece and the second restricting piece, the second pathway is defined between the first restricting piece and the diversion block, and the fourth pathway is defined between the second restricting piece and the diversion block.

13. The sorting apparatus of claim 12, wherein widths of the first pathway, the second pathway, and fourth pathway are the same, a width of the first pathway is narrower than diameters of the screw caps of the long and the short screws, and the width of the first pathway is wider than diameters of screw poles of the long and the short screws.

14. The sorting apparatus of claim 13, wherein top portions of the first and the second restricting pieces are placed below the screw caps of the long and the short screws.

15. The sorting apparatus of claim 13, wherein top portions of the first restricting piece, the second restricting piece, and the diversion block are located on a same plane.

16. The sorting apparatus of claim 15, wherein a top portion of the first block is located below the a top portion of the first restricting piece, a distance between the top portion of the first restricting piece and the top portion of the first block is smaller than a length of the screw pole of the long screw and larger then a length of the screw pole of the short screw.

17. The sorting apparatus of claim 12, wherein a cover is mounted above the diversion block to pervert the long and the short screws from jumping out of the sorting apparatus.

18. The sorting apparatus of claim 12, wherein the diversion block comprises a first side face, the second restricting piece is parallel to and faces to the first side face, and the fourth pathway is defined between the second restricting piece and the first side face.

19. The sorting apparatus of claim 18, wherein the diversion block further comprises a second side face, the first restricting piece is parallel to and faces to the second side face, and the second pathway is defined between the first restricting piece and the second side face.

20. The sorting apparatus of claim 19, wherein the first second side face and the second side face are crossed.
